(19) United States
(12) Patent Application Publication
(10) Pub. No.: US 2023/0417572 A1
(43) Pub. Date: Dec. 28, 2023

(54) Mapping Road Conditions in an Environment

(71) Applicant: GM Cruise Holdings LLC, San Francisco, CA (US)

(72) Inventor: Burkay Donderici, Burlingame, CA (US)

(73) Assignee: GM Cruise Holdings LLC, San Francisco, CA (US)

(21) Appl. No.: 17/848,533

(22) Filed: Jun. 24, 2022

(51) Int. Cl. G01C 21/00; B60W 60/00

(52) U.S. Cl. CPC G01C 21/3822; B60W 60/001; B60W 2420/54; B60W 2552/05

(57) ABSTRACT

An autonomous vehicle includes sensors proximate to one or more wheels that capture wheel sensor data describing wheel-road interactions. The wheel sensor data may be processed to determine characteristics of the road as the vehicle travels, describing the relative audible, vibratory, or pressure effects of the wheel-road interaction. The wheel sensor data and/or characteristics may then be used to generate a road sensor map describing locations of received wheel sensor data and/or detected road conditions. The wheel sensor data and/or road sensor map may also be used to refine or correct localization of the AV within the environment. In navigation, the AV may use a prior road sensor map for route planning and control, for example to prioritize movement over relatively smooth roads or to navigate to regions with unmapped or aging road information.

### BACKGROUND

This disclosure relates generally to environment mapping and more particularly to mapping an environment with wheel-adjacent sensor data.

Autonomous vehicles (AVs) navigate in environments by sensing its environment with various types of sensors to determine the current state of the environment. In general, AVs identify information in the environment with sensors such as image sensors (e.g., cameras) and may also use LIDAR or RADAR sensors to measure distances to objects in the environment. Despite advances in the accuracy of these sensors and in perception algorithms, additional details remain that may be determined from the environment to be effectively represented and mapped by the AV to improve accuracy of the perceived environment relative to actual physical conditions of the environment.

### BRIEF DESCRIPTION OF THE DRAWINGS

FIG. 1 shows example components of an autonomous vehicle, according to one embodiment.

FIG. 2 shows components of the control system, according to one embodiment.

FIGS. 3A-3F show example road sensor maps and use thereof, according to various embodiments.

FIG. 4 shows an example data processing flow for a road sensor map, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

To increase perception of the environment, an autonomous vehicle (AV) includes one or more sensors proximate to the wheels of the AV for capturing wheel sensor data describing wheel-road interactions. These sensors may include audio, vibratory, and/or pressure sensors that provide the AV information about the road-wheel interface. As different types of conditions of the road and wheel may affect travel of the wheels along the road (e.g., the relative smoothness of the road, amount of “bounce” in the wheels, etc.), the wheel sensor data may be analyzed to characterize various conditions from the sensor data road conditions, environmental conditions, and/or tire conditions (e.g., smooth asphalt, rough asphalt, gravel, rain, sleet, tire wear and tire pressure, etc.).

As the wheel sensor data may be a function of the wheel, the surface it interacts with, and other environmental conditions, the wheel sensor data may be processed to determine various types of conditions, affecting road-wheel interactions, such as a particular road condition, wheel condition, and environmental condition for a given portion of the wheel sensor data. The wheel sensor data may be processed with a machine-learned model or signal processing techniques based on a library of wheel sensor data and associated conditions that may be used to determine the currently-detected conditions.

The wheel sensor data and/or the road conditions may then be used to generate a road sensor map of the environment of the vehicle, permitting the road to be described in finer-grained detail and in relation to road-wheel interaction effects. The road sensor map may describe portions of the environment as captured by the wheel sensor data and the respective road conditions inferred for those portions. The wheel sensor data may also be used to infer environmental conditions (e.g., relative water/rain effects) or tire conditions (wear or pressure).

The determined road sensor map may then be used to update a prior road sensor map or as a map to be used for future navigation. For example, detected rough or textured areas in the road may be avoided in future motion planning by AVs, either to modify the portion of a lane traveled by an AV or to discourage use of a lane entirely. In addition, the data described in the prior road sensor map may have an associated time at which the data was captured and may have an associated decay, such that the information may become out of date. In addition to navigating to avoid “rough” areas of the road and smoothing travel of the AV, the AV may also navigate to capture data about a “region of interest” based on the prior road sensor map. Such “regions of interest” may include portions of the road that have not been mapped or that are associated with old mapping data.

In addition, the wheel sensor data and/or detected road conditions may also be used to update localization information of the AV, e.g., to determine the positioning of the vehicle or wheels (e.g., individual wheels) by comparing the currently-detected sensor data (optionally as processed to road conditions and/or a current road sensor map) with a prior road sensor map. This may be used, for example, to identify a finer-resolution position of the vehicle relative to other localization information and may also be used to verify or correct the perceived position of the vehicle within the environment.

As such, detection of wheel-road interaction information from wheel sensor data and incorporation of detected road and wheel conditions into mapping and perception of the AV may improve accurate representations of the environment and improve operation of the AV with respect to the physical environment.

Additional details and variations of these aspects are further discussed in detail below.

As will be appreciated by one skilled in the art, aspects of the present disclosure, may be embodied in various manners (e.g., as a method, a system, a computer program product, or a computer-readable storage medium). Accordingly, aspects of the present disclosure may be implemented in hardware, software, or a combination of the two. Thus, processes may be performed with instructions executed on a processor, or various forms of firmware, software, specialized circuitry, and so forth. Such processing functions having these various implementations may generally be referred to herein as a “module.” Functions described in this disclosure may be implemented as an algorithm executed by one or more hardware processing units, e.g., one or more microprocessors of one or more computers. In various embodiments, different steps and portions of the steps of each of the methods described herein may be performed by different processing units and in a different order, unless such an order is otherwise indicated, inherent, or required by the process. Furthermore, aspects of the present disclosure may take the form of one or more computer-readable medium(s), e.g., non-transitory data storage devices or media, having computer-readable program code configured for use by one or more processors or processing elements to perform related processes. Such a computer-readable medium(s) may be included in a computer program product. In various embodiments, such a computer program may, for example, be sent to and received by devices and systems for storage or execution.

This disclosure presents various specific examples. However, various additional configurations will be apparent from the broader principles discussed herein. Accordingly, support for any claims which issue on this application is provided by particular examples, as well as such general principles, as will be understood by one having ordinary skill in the art.

In the following description, reference is made to the drawings where like reference numerals can indicate identical or functionally similar elements. Elements illustrated in the drawings are not necessarily drawn to scale. Moreover, certain embodiments can include more elements than illustrated in a drawing or a subset of the elements illustrated in a drawing. Further, some embodiments can incorporate any suitable combination of features from two or more drawings.

As described herein, one aspect of the present technology may be the gathering and use of data available from various sources to improve quality and experience. The present disclosure contemplates that in some instances, this gathered data may include personal information. The present disclosure contemplates that the entities involved with such personal information respect and value privacy policies and practices.

The following disclosure describes various illustrative embodiments and examples for implementing the features and functionality of the present disclosure. While particular components, arrangements, or features are described below in connection with various examples, these are merely examples used to simplify the present disclosure and are not intended to be limiting.

Reference may be made to the spatial relationships between various components and to the spatial orientation of various aspects of components as depicted in the attached drawings. However, the devices, components, members, apparatuses, etc. described herein may be positioned in any desired orientation. Thus, the use of terms such as “above,” “below,” “upper,” “lower,” “top,” “bottom,” or other similar terms to describe a spatial relationship between various components or to describe the spatial orientation of aspects of such components, should be understood to describe a relative relationship between the components or a spatial orientation of aspects of such components, respectively, as the components described herein may be oriented in any desired direction. When used to describe a range of dimensions or other characteristics (e.g., time, pressure, temperature, length, width, etc.) of an element, operations, or conditions, the phrase “between X and Y” represents a range that includes X and Y.

In addition, the terms “comprise,” “comprising,” “include,” “including,” “have,” “having,” or any other variation thereof, are intended to cover a non-exclusive inclusion. For example, a method, process, device, or system that comprises a list of elements is not necessarily limited to only those elements but may include other elements not expressly listed or inherent to such method, process, device, or system. Also, the term “or” generally refers to an inclusive use of “or” (including combinations of listed elements) rather than an exclusive use of “or” (exclusive selection of one element) unless expressly indicated or otherwise inherent to the use of “or.”

### System Overview

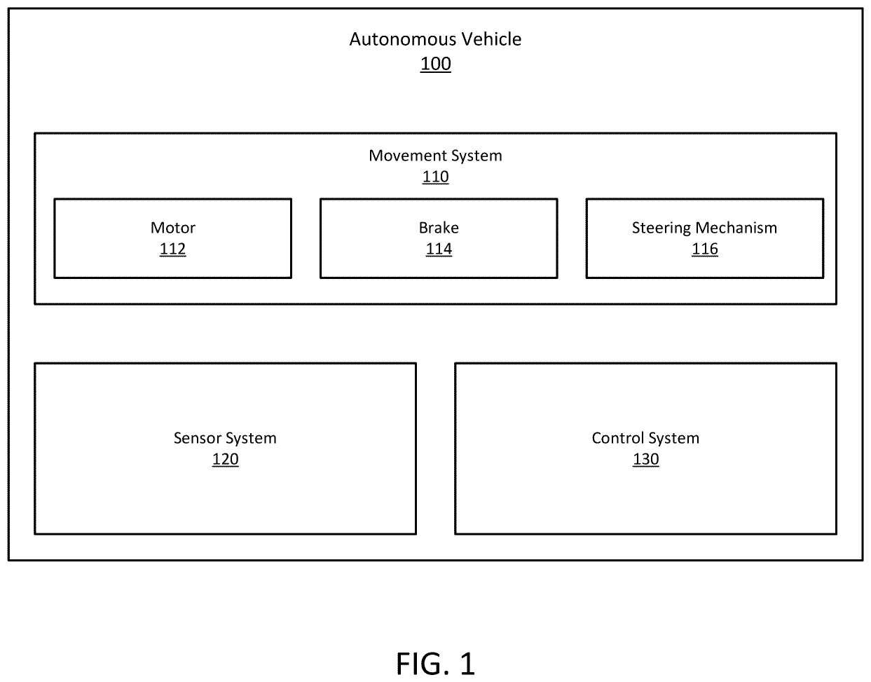

FIG. 1 shows example components of an autonomous vehicle 100, according to one embodiment. In general, an autonomous vehicle 100 includes a movement system 110 to affect physical movement of the autonomous vehicle 100 within an environment surrounding the vehicle, a sensor system 120 that includes a set of sensors for capturing information about the movement of the autonomous vehicle 100 and receiving information about the environment, and a control system 130 that perceives the environment and provides control to the movement system 110 for moving the autonomous vehicle 100 within the environment. In various embodiments, the autonomous vehicle 100 may be completely autonomous and the movement system 110 may be controlled without manual user operation, and in other embodiments may be partially autonomous, such that certain functions or features are automatically provided by the control system 130. In other instances, a user may manually control operation of the movement system 110, for example through various types of manual control mechanisms or inputs, such as pedals, steering wheel, gearbox control, etc. Such manual operation may be provided by an occupant of the autonomous vehicle 100 or may be provided remotely via a communication link to an external operator. In some embodiments, the autonomous vehicle 100 may transition operation to modes with more or less autonomous control based on various conditions, such as a user request, vehicle conditions, or environmental conditions. The autonomous vehicle 100 may also operate with or without an occupant in various embodiments or may activate or deactivate autonomous functions based on occupancy. In some embodiments the autonomous vehicle 100 may include no passenger cabin.

The movement system 110 includes various components for affecting movement of the autonomous vehicle 100 in the environment. As such, the movement system 110 may include a motor 112 that may be connected to a drive system (e.g., wheels) that moves the autonomous vehicle 100. The motor 112 may have multiple operation modes for moving forward, backward, or set to neutral, and may also be set to different speeds/torques (e.g., via various gear ratios). The motor 112 may also be capable of different levels of power output as controlled by a throttle. The movement system 110 may also include a brake 114 for slowing or stopping the movement of the autonomous vehicle 100 along with a steering mechanism 116 for changing the direction of travel of the autonomous vehicle 100. In general, the particular implementation of the components of the movement system 110 enable the autonomous vehicle to start, stop, and change direction in its environment, and may vary according to the particular type of the autonomous vehicle 100. Generally, the movement system 110 thus represents the mechanical components for movement and are controlled by signals received from the control system 130 that designate, for example, an amount of output by the motor, a steering direction for the steering mechanism 116, and so forth.

The sensor system 120 includes a set of sensors for monitoring the autonomous vehicle 100 and the environment around the autonomous vehicle 100. The particular set of sensors and the arrangement thereof may vary according to different examples. As examples, the sensors may include various sensors for monitoring the mechanical performance of the autonomous vehicle 100, such as sensors for monitoring motor performance, fluid levels, air pressure, wheel rotation speed, etc.

The sensors may also include various sensors for localization of the autonomous vehicle 100 within the environment and for perceiving the environment of the autonomous vehicle 100. In general, these sensors may capture various types of modalities of information, such as audio, video, and various electromagnetic frequencies. The sensors may include passive (e.g., receipt-only) and active sensing technologies (e.g., environmental scanning with active transmission and receipt of a return signal). Although certain sensors are discussed here, in practice, more or fewer sensors may be included according to the particular configuration of the various embodiments. The sensors may include one or more imaging sensors, which may include visible-light imaging sensors (e.g., a camera) or an infrared (IR) imaging sensor, radio detection and ranging (RADAR) sensors, or light detection and ranging (LIDAR) sensors. The sensors may also include a receiver for global positioning satellite (GPS) location data, a compass, and receivers for wireless signals, such as cellular or other wireless networks. The sensors may also include receivers for various electromagnetic (EM) signals in various frequencies along with microphones for receipt of audio and other sound information from the environment.

The sensors may include one or more sensors for capturing wheel sensor data describing wheel-road interactions. These sensors are placed proximate to one or more wheels of the autonomous vehicle to capture information resulting from wheel-road interactions, such as moving the wheel on the road. As discussed below, this wheel sensor data may be processed to determine various characteristics, such as road characteristics, wheel characteristics, and/or environmental characteristics. Different types of sensors may be used for capturing wheel sensor data, such as audio sensors (e.g., microphones), vibration sensors, and/or pressure sensors. In various embodiments, different types of these sensors may be included and may be included for the vehicle as a whole or for individual wheels. For example, in one embodiment a microphone is placed underneath the autonomous vehicle which may capture audio information from all of the vehicle wheels, while in another embodiment, each wheel may have an associated microphone, e.g., in the wheel well, which captures audio information primarily characterizing the respective wheel. Multiple types of sensors may also be used and placed differently—for example, a vibratory sensor may be centrally located to capture vibration that may arise from any of the wheels and affect the vehicle as a whole, and an audio sensor may be simultaneously placed at each wheel to capture sounds proximate to each wheel. A pressure sensor on a wheel may also measure the pressure of the ground with respect to the wheel.

In general, the sensors for generating wheel sensor data may generally capture data affected by the type and quality of the wheel-road interactions as the wheel moves along the road, for example the road noise, vibration, or changing pressure of the road. Each of these may be affected by the type of road (e.g., smooth asphalt, cracked asphalt, gravel, dirt) and used by the control system 130 to determine characteristics of the environment as the AV travels.

Each sensor may also capture information in respective data formats and modalities according to the capacities of the sensors. For example, an imaging sensor typically captures received light as a two-dimensional image having one or more channels. As such, a visible light camera typically describes color images with color channels in an image space (e.g., as values of red-green-blue, hue-saturation-lightness, hue-saturation-value, cyan-yellow-magenta-key, etc.), while an infrared camera may describe received infrared frequencies in one channel. Similarly, audio capture with a microphone may be described as a frequency waveform, while RADAR/LIDAR data may be represented as a point cloud of data points representing the environment as points at varying distances from the sensor.

The position and placement of the sensors may also vary according to different embodiments and may be calibrated with respect to characteristics of each individual sensor and also with respect to one another to determine the relative position and orientation of each sensor to translate information captured from each sensor to a joint coordinate system. This may permit data from multiple sensors to be aligned to a common coordinate system such that information from multiple sensors may be jointly interpreted.

The sensors may also include various sensors for perceiving the internal condition of the autonomous vehicle 100, such as a microphone to receive any noises or audible instructions from a passenger within the vehicle or a camera for viewing the passenger cabin.

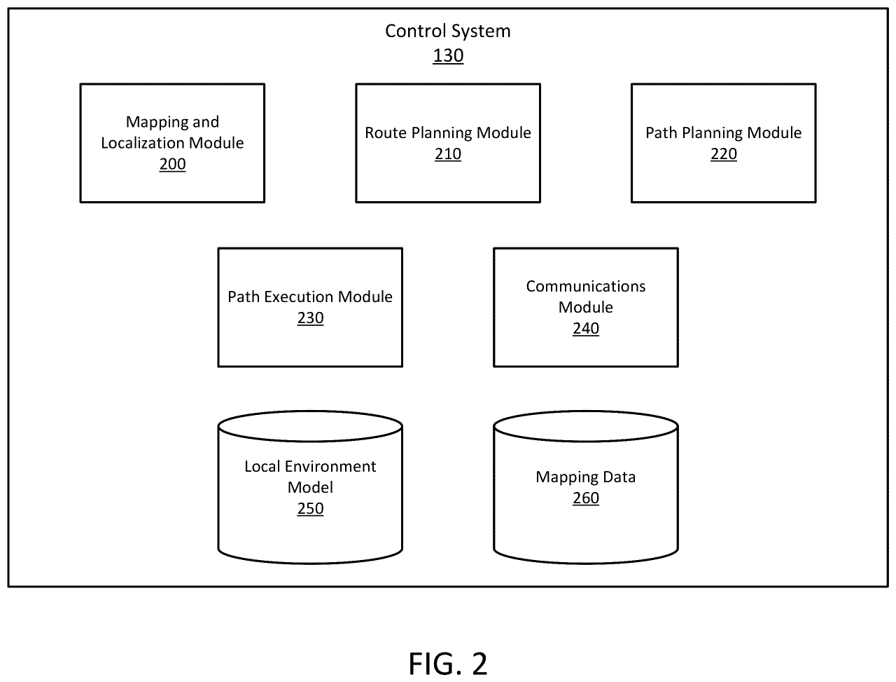

The control system 130 receives sensor data from the sensor system 120 and generates signals for the control of the components of the movement system 110 to navigate the autonomous vehicle 100 within its environment. The control system 130 thus may include components for perceiving the environment based on the sensor data, planning movement, and executing movement with control signals. The control system 130 is further discussed in FIG. 2.

Although generally the autonomous vehicle 100 refers to a vehicle typically operated on a road, such as a car, light truck, heavy truck, principles of this disclosure may also apply to other types of autonomously- or partially-autonomously-operated vehicles. Such additional types of autonomous vehicles 100 may include aerial vehicles such as drones, helicopters, or planes, as well as aquatic vehicles including surface and sub-surface vehicles. As such, the principles discussed herein may generally apply to systems that sense environmental information, analyze, and perceive aspects of the environment, and/or provide for automated control of the autonomous vehicle 100.

Not shown in FIG. 1 are various additional components that may be included in various embodiments and are omitted for the purpose of simplifying the discussion herein. For example, the autonomous vehicle 100 may include lights (e.g., headlights, brake lights, etc.), signaling mechanisms, access control (e.g., door locks), battery, fuel storage, and other suitable components.

FIG. 2 shows components of the control system 130, according to one embodiment. The control system 130 includes various components for processing sensor data to perceive the environment of the autonomous vehicle 100 and provide control signals to the movement system 110. The control system 130 may include various computing modules and data storage elements. To perceive and understand the environment, a mapping and localization module 200 may generate and maintain a local environment model 250 that describes conditions of the current environment around the autonomous vehicle 100, such as various objects perceived in the environment based on received sensor data and in conjunction with a set of mapping data 260. Additional modules, such as a route planning module 210, a path planning module 220, and a path execution module 230, determine and execute long- and short-term movement planning. Finally, a communications module 240 may communicate with external systems, both to coordinate movement of the autonomous vehicle 100 and to update software and data components.

In further detail, the mapping and localization module 200 determines and maintains the local environmental model 250 and may implement an environment perception stack for identifying objects and characteristics of the environment. The local environment model 250 may thus describe individual objects in the environment, e.g., objects, people, trees, signs, etc., in a virtual model of the environment consistent with the sensor data. The position of the objects relative to one another along with a current velocity (e.g., with respect to other objects, non-moving/background objects, or the autonomous vehicle 100) may be characterized in the local environmental model 250. The mapping and localization module 200 may also predict future movement of the perceived objects at various timeframes based, e.g., on the current velocity, as well as other sensed data that may predict future change in heading or intention by the object. As such, while the current velocity of a detected object may be expected to continue for at least a short timeframe (e.g., 50 ms), over longer timeframes the objects may be predicted to continue at that heading and speed, slow down, speed up, change direction, and so forth. For example, when a “stop” sign is in the environment ahead of a vehicle, the vehicle may be expected to change its speed to reduce speed and likely stop in the vicinity of the stop sign. The expected movement of objects at different timeframes may thus be predicted with different levels of confidence and may be probabilistically represented according to different types of actions that may be inferred for moving objects. For example, a pedestrian on a street corner may continue to stand at the corner or may, at some future time, enter the street to cross.

To build and update the local environment model 250, the mapping and localization module 200 may process the received data from the various sensors and apply object recognition, motion prediction, and localization algorithms. That is, the mapping and localization module 200 determines objects in the environment, predicts how those objects may move, and determines the location of the autonomous vehicle 100 in relation to the environment. The state of the local environment may thus be stored as the local environment model 250.

To describe the local environment, the sensed information may be processed by various algorithms for perception and object detection. The various sensor data may be individually processed as well as processed in combination with other sensor data of the same or different types. For example, in some embodiments, multiple image sensors may overlap in the portions of the environment viewable by the respective sensors. The captured images may be stitched together to form a larger image for the combined regions, and the respective difference in apparent size and position of an object from the cameras may also be used to infer distance to the object from the images. In some embodiments, imaging sensors may be disposed around the autonomous vehicle, such that the captured images may be merged to form a panoramic view of the environment. In addition, the captured image data and other sensor data (e.g., RADAR and LIDAR point cloud data) may be processed by one or more neural networks for object segmentation and identification. These networks may perform processing on sensor data individually (e.g., initial object identification based on image or LIDAR data alone) and may include networks (or network layers) for joint processing of multiple sensor types together. The current local environment model 250 may also be sequentially generated and updated at a frequency based on the sensor information since the last update. As such, each local environment model 250 may represent a “frame” of the perceived environment. In addition, the current local environment model 250 may also account for prior captured sensor data (e.g., of a prior frame) and prior frames of the local environmental model in constructing a current local environment model 250. This may permit, for example, object and motion tracking over time to improve object classification as well as movement prediction and to account for objects which may be temporarily obscured by other objects. In some embodiments, the construction and maintenance of the local environment model 250 may be performed based on the captured sensor data by the sensor system 120.

The environment mapping may also be performed in conjunction with information from the mapping data 260. The mapping data 260 stores longer-term data about various regions that may be used for localization and route planning. For example, the mapping data 260 may include roads, landmarks, coordinates, road signs and other road control information, and various other information associated with a mapping of the world that is generally expected to be relatively stable over time. Detected objects and other sensor data may be used to determine the position of the autonomous vehicle with respect to the known information in the mapping data 260. For example, the GPS location information may be used to determine the likely position of the vehicle with respect to the mapping data 260. However, as GPS location information may be distorted or imprecise, particularly when navigating environments with many buildings or other interference, additional information may be used to synchronize the perceived environment with the mapping data 260. For example, locally-perceived objects and other signatures of the environment may be matched with known landmarks and characteristics in the mapping data 260. After determining the location of the autonomous vehicle with respect to the mapping data 260, the local environment model 250 may also be supplemented with information from the mapping data 260, for example, to provide information about areas of the environment beyond the perception range of the sensors of the sensor system 120. This information may be useful, for example, for longer-term motion planning or movement prediction of other objects. For example, the sensors may perceive objects that obscure road signs from the sensor system 120 that may be known or expected in the environment based on the mapping data 260.

The local environment model 250 may also be used to update the mapping data 260 when the locally-sensed data differs from the mapping data 260. For example, the sensor data may not perceive a road sign at a location designated in the mapping data 260 despite a view of that location, or a road may be closed or under construction or otherwise in a different condition than designated in the mapping data 260. The mapping and localization module 200 may communicate differences between the mapping data 260 and the locally-perceived environment to an external system that maintains the mapping data 260.

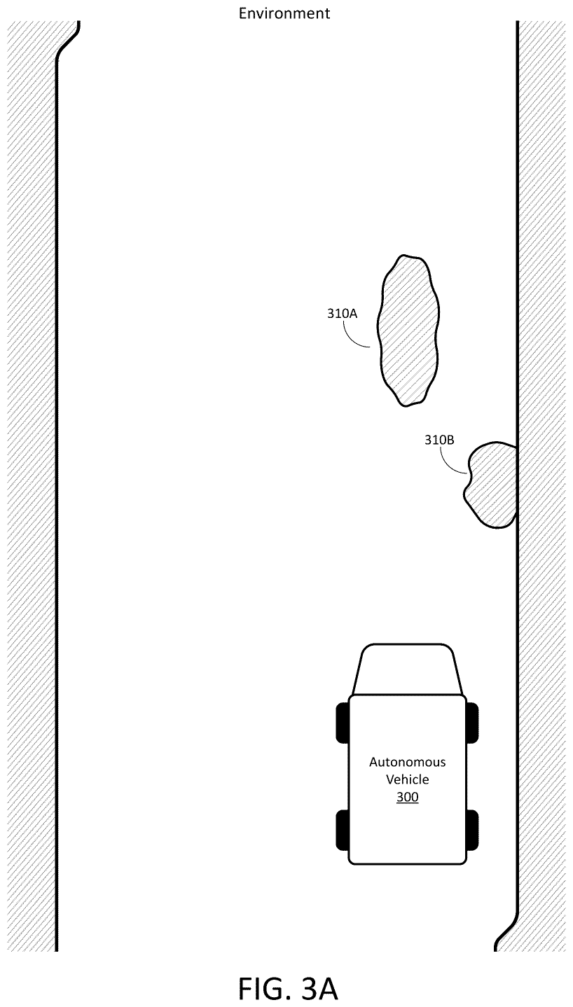

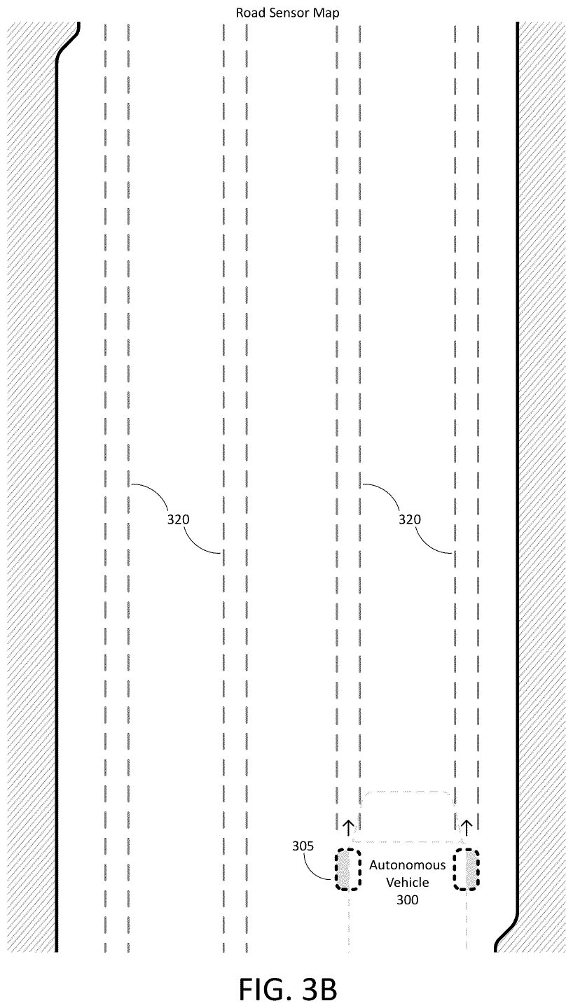

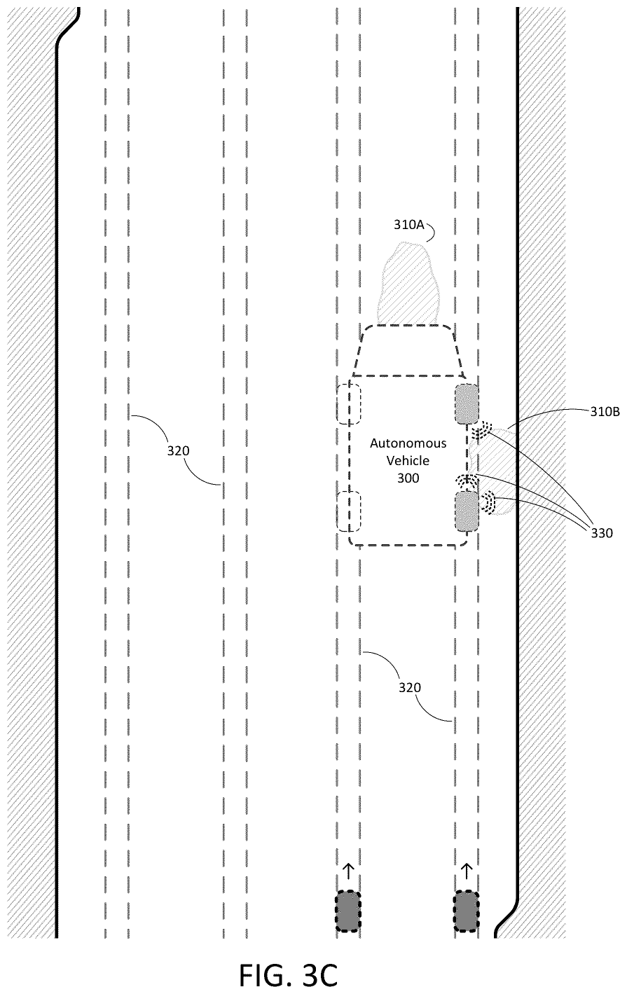

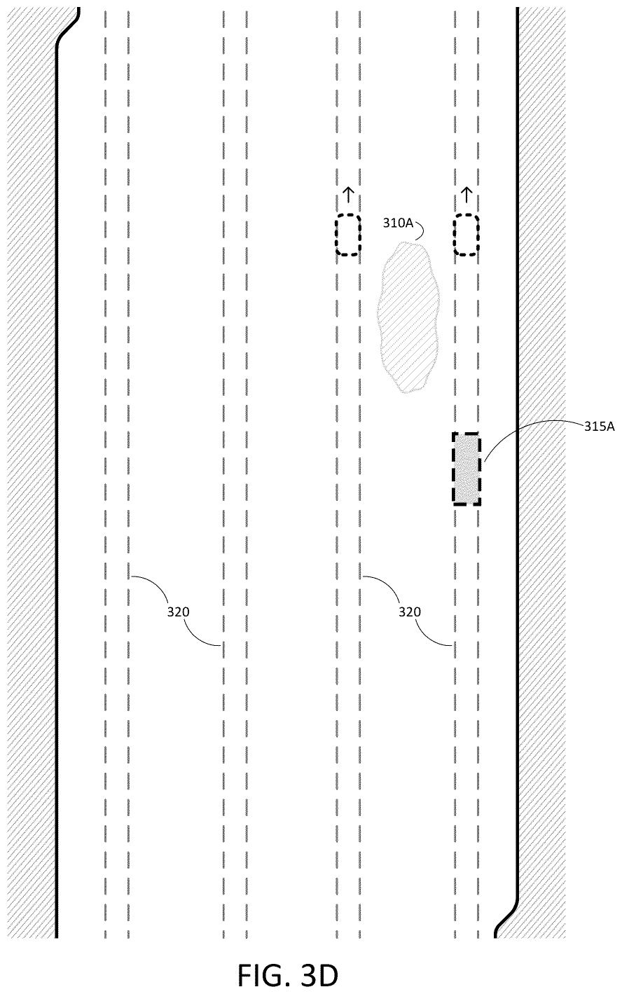

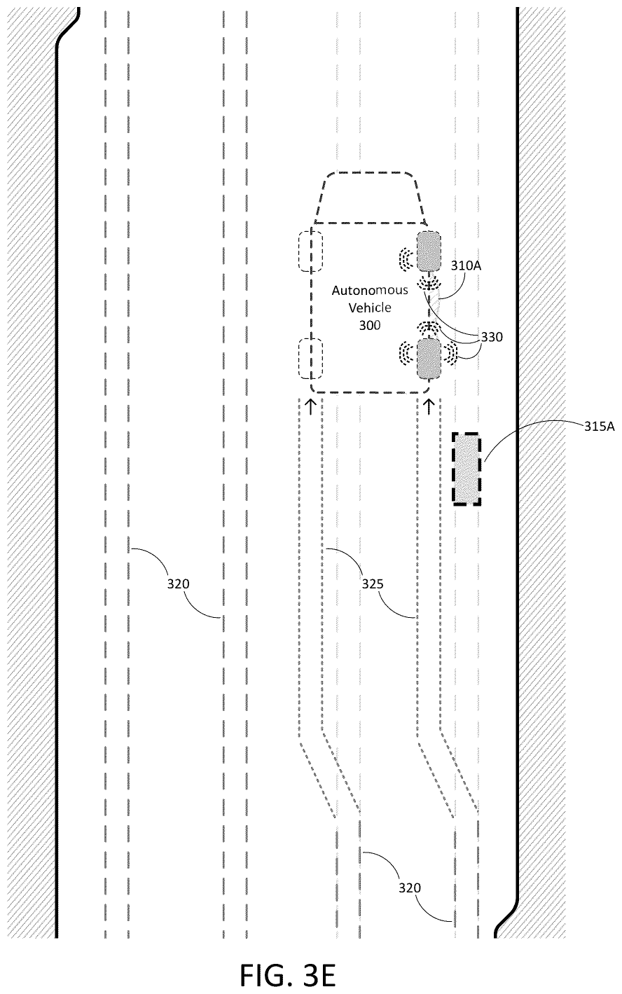

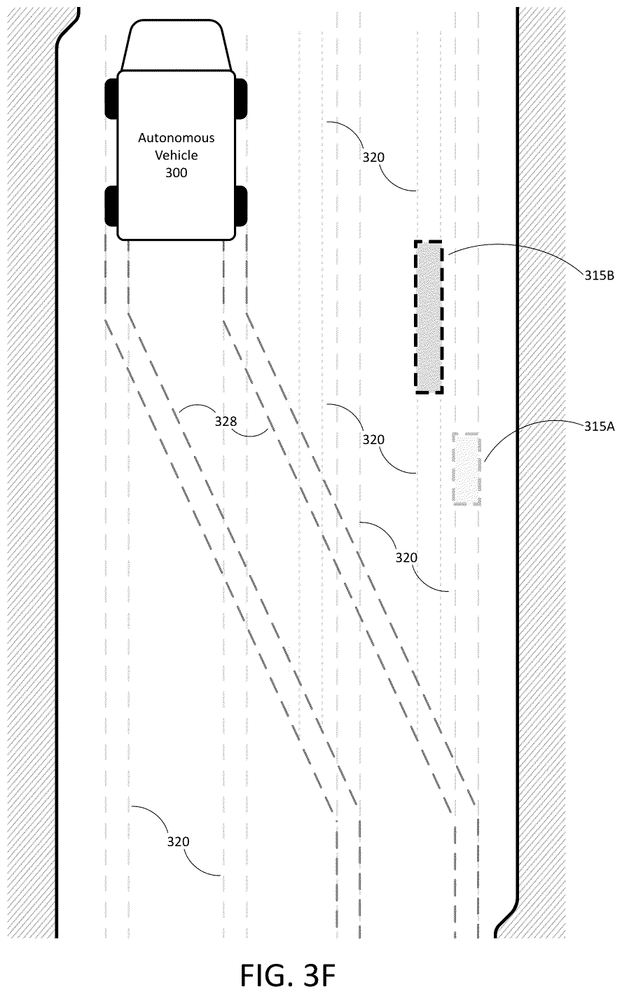

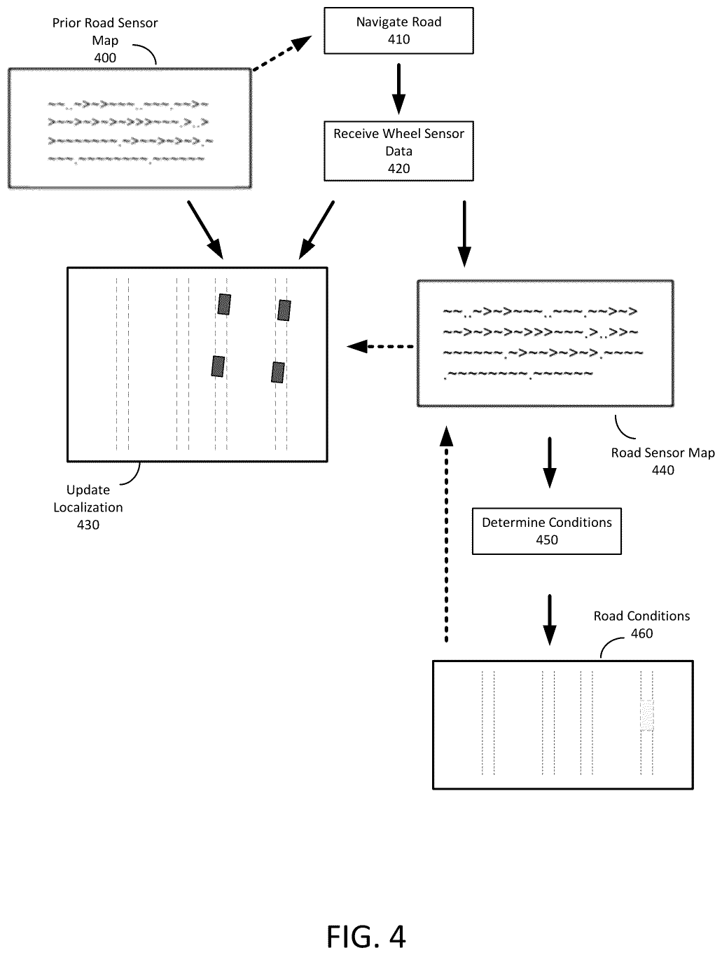

In some embodiments, the mapping and localization module 200 processes wheel sensor data to determine various characteristics based on the respective sensors that receive information proximate to one or more of the wheels. This may include, for example, road characteristics describing the type of road traversed by the autonomous vehicle, wheel characteristics describing the condition of the wheel, and/or environmental characteristics describing aspects of the environment that may affect AV mapping or navigation. The sensor data and/or detected characteristics may be used to generate a road sensor map as a part of the local environment model 250. The mapping data 260 may also be updated based on the road sensor map and sent to other devices for updating by the communications module 240. The mapping data 260 may also include a prior road sensor map that may be used for further path planning and navigation, for example to avoid or preference a portion of the road based on the information captured from the wheel sensor data. In addition, the prior road sensor map may be used in conjunction with current wheel sensor data for additional localization of the AV within the environment. Road sensor maps are discussed further below with respect to FIGS. 3A-4.

The route planning module 210 determines longer-range planning and routing for the autonomous vehicle 100 and may determine, for example, an expected navigation route from an origin to a destination. Conceptually, the route planning module 210 may determine the high-level navigation objective and route, in contrast to the path planning module 220, which may determine short-term navigation with respect to the local environment model 250. While discussed here as separate components, in practice, these components may be jointly implemented, and the longer-term route planning may be affected by information discovered from the local path execution or environmental perception. For example, a planned route may indicate travel along a road that the local environment model 250 indicates is not available or for which there is no executable path to reach, such that another destination or route must be determined.

The route planning module 210 may determine the current location of the autonomous vehicle 100 and a destination and the overall route (e.g., individual roads and turns) to arrive at the destination from the current location. The route may be determined by available ways to reach the destination from the origin and evaluated with respect to traversal costs such as expected travel speeds, fuel usage, time, ride smoothness/passenger comfort, traffic, and so forth. The available ways of reaching the destination may be explored by various traversal algorithms based on the costs of traversing different routes and cost preferences for combining different types of costs.

The route planning module 210 may also receive instructions from an external system specifying a route or a destination. For example, the external system may coordinate destinations for many autonomous vehicles, such as destinations for passenger or cargo pickup/delivery, for vehicle maintenance or refueling, and so forth. The destination and/or a route for reaching the destination may thus be determined by the route planning module 210 or provided by the external system.

The path planning module 220 determines a path for navigating the local environment based on the local environment model 250 and the desired route specified by the route planning module 210. As such, the route from the route planning module 210 may provide a route indicating that the autonomous vehicle should turn right at the next street in approximately two miles. The path planning module 220 evaluates objects in the local environment (e.g., other cars, pedestrians, etc.) and determines the desired path for the autonomous vehicle 100 to navigate to and execute the turn. This may include, for example, changing lanes to a turn lane based on available space in the turn lane, stopping at the intersection, executing the turn, and so forth.

The path planning module 220 may look ahead an amount of time in predicting the movement of objects during its planning and update the planned path for each frame that the local environment model 250 is updated. The path planning module 220 may thus provide desired speed, turning, and other information to the path execution module 230 for execution.

The path execution module 230 executes the path with the various movement control signals for the movement system 110 to execute. Such signals may control application of the throttle, brake, and steering to execute the planned path. The path execution module 230 may include feedback mechanisms for verifying expected execution of the signals by the movement system 110, for example, to confirm a wheel-speed sensor is affected by application of the brake or throttle or that the specified speed along the path is achieved by the applied throttle signal. As such, the path execution module 230 translates the higher-level path instructions to specific signals that control the physical components of the movement system 110.

The communications module 240 coordinates messaging with other systems and devices. As one example, the communications module 240 may be used for updating the mapping data 260 based on data kept by an external data source. As another example, the communications module 240 may provide diagnostic, operations, and safety information for monitoring of the autonomous vehicle 100. As such, the communication module 240 may use respective communication components (e.g., transceivers) for various communication modalities such as cellular or wireless communications.

The control system 130 may include additional modules or components for control and management of the autonomous vehicle 100 that are not explicitly shown here. For example, the control system 130 may include voice recognition and control components for interpreting commands by a passenger, a module for coordinating communication of the passenger with a remote technician via the communications module 240, and modules for operating various other features or components of the vehicle.

### Road Sensor Mapping

FIGS. 3A-3F show example road sensor maps and use thereof, according to various embodiments. As noted above, the AV may include sensors that capture wheel sensor data that may be used to describe wheel-road interactions. Various types of conditions may be determined from the wheel sensor data, such as road conditions, wheel conditions, and environmental conditions. In particular, wheel sensor data and/or road condition information may be used to generate a road sensor map that describes wheel sensor data and/or detected road conditions at different portions of the road. Data regarding wheel sensor data or detected conditions may also be shared with or received from an external system or other AVs, such that the AV may have a prior road sensor map for different portions of the environment. FIGS. 3A-3F illustrate an AV in an environment with a prior road sensor map, detecting conditions for generating a current road sensor map, updating the road sensor map, and using road sensor maps for navigating the environment. In general, the road sensor map thus associates wheel sensor data (and/or various further processing of the wheel sensor data) with traversed areas of the environment. The road sensor map may characterize locations/positions in the map with any suitable information that may be used to distinguish and compare data captured by different times or by different vehicles (e.g., such that the information describing a position(s) in the map may be compared at different times or by different vehicles). As such, the road sensor map in various embodiments may include “raw” wheel sensor data, processed wheel sensor data (e.g., describing a frequency, or amplitude of the wheel sensor data), detected road conditions, and/or other information derived from the wheel sensor data and associable with a location in the environment.

As discussed more fully below, the AV may use a prior road sensor map to guide current navigation and/or to improve localization of the vehicle based on the currently-detected wheel sensor data as compared to the “known” (i.e., previously mapped) wheel sensor data reflected in a prior road sensor map. In addition, as the vehicle navigates its environment, it may generate a road sensor map (or a portion thereof) for areas of the environment traversed by the AV, which may be used to modify the prior road sensor map or affect the AV's navigation (e.g., when the locally-detected wheel sensor data or road sensor map differs from the expected prior road sensor map).

FIG. 3A shows an environment in which an AV 300 may travel, including a two-lane road. In this example, the road is relatively smooth and includes two rough areas 310A-B. This may represent, for example, a road which is in relatively “good” condition, but which has gradually deteriorated such that portions of the road are beginning to crack and break, resulting in rough areas 310A-B. As such, in this example the road may generally be a paved asphalt, with the rough areas 310A-B as cracked, broken, potholes, or other deteriorations that may affect the AV 300 (e.g., passenger comfort or causing additional wheel/tire wear). As discussed more fully below, processing of the wheel sensor data may enable the AV to recognize, as a “road condition,” different types and qualities of road, such as “smooth asphalt” or “cracked asphalt” or “potholes.” Relative to the captured wheel sensor data, different types of road conditions may generate louder sounds, increased vibration, or variations in relative wheel pressure, for example, as an interaction with the wheel to the road (e.g., bounces) with comparatively rougher or bumpier textures.

FIG. 3B shows an example of the environment as represented in a prior road sensor map. In this example, the AV 300 has a road sensor map of the same environment which may be based on prior travel by the same AV 300 through the environment, or may be received from an external system, such as another AV or an external system that coordinates data, routing, and/or control for AVs. The road sensor map describes detected wheel sensor data and/or subsequent processing thereof, which may be stored/described in different ways in different embodiments. The wheel sensor data itself may be stored or may be processed to identify individual road conditions. In some embodiments, the data may be described with respect to a point (i.e., at this specific point the following wheel sensor data and/or conditions were detected) or may be a one-dimensional array of data along a road (e.g., a sequence of detected wheel sensor data and/or road conditions from one point of a road sensor map to another point of the road sensor map). In other embodiments, the road sensor map may include data describing road conditions in two dimensions (e.g., in relation to coordinates across latitude and longitude or other directional orientations of the map).

In the example of FIG. 3B, the road sensor map includes mapped data 320 representing wheel sensor data captured by vehicles driving in each of the respective lanes for the illustrated road. In this example, the mapped data 320 includes data for a portion of the road, representing a vehicle driving roughly in the center of each lane and describing the wheel sensor data detected during that travel. As such, the mapped data 320 in this example does not currently reflect the rough areas 310A-B in the actual environment as shown in FIG. 3A. As vehicles travel through the same locations, different portions of the road may be traversed by different vehicles, such that different portions of the road are captured by different vehicles and may be shared by different AVs (e.g., with an external system) to assemble a more complete road sensor map.

As the AV 300 enters the environment, the AV 300 may determine its location (e.g., localize itself) with respect to the environment to determine its position and retrieve a prior road sensor map of the environment (e.g., as shown in FIG. 3B). The prior road sensor map may also be used to affect routing and planning of the AV 300, e.g., by the route planning module 210 or the path planning module 220. For example, the mapped road conditions may be used to preference or penalize routes or planned paths based on the prior road sensor map, for example to preference relatively smooth roads or portions thereof and to avoid rough or difficult to navigate roads. The route planning module 210 may, for example, plan routes based in part on the road quality (determined from the road sensor map) and whether there is a high-quality path for navigating a road segment (e.g., a portion of a road between two intersections) in the route. Similarly, when planning movements more locally, the path planning module 220 may use the road sensor map to select a particular lane or portion of a lane for travel, as further explored in the following discussion. Portions of a road that are relatively smooth may be preferred relative to portions of the road that are relatively rough and used to plan travel and select lanes or a portion of a lane (e.g., left-, middle-, or right-justified in the lane) for travel.

In the example of FIG. 3B, the AV 300 may be localized to determine that the AV is traveling along an environment corresponding to the prior road sensor map showing mapped data 320. In this example, as the mapped data 320 indicates a relatively smooth road in each lane and the AV 300 is currently in the right lane, the AV may be navigated based on the road sensor map to continue in the right lane with a relatively centered alignment with respect to the width of the lane.

FIG. 3C shows the travel of the AV 300 in the environment in the right lane. As the right wheels of AV 300 travel over the rough area 310B of the road, the wheels on the right side of the AV 300 may sound louder, create vibrations, or experience pressure changes that are captured by respective types of sensors near the AV wheels and may processed to discern the rough area 310B as differing from the data in the prior road map, e.g., as different wheel sensor data or a different road condition. To detect conditions from the received wheel sensor data, the mapping and localization module 200 may perform various types of data processing in different environments.

The following are various examples of the types of conditions that may be detected based on the wheel sensor data:
Road conditions:
   Asphalt
   Concrete
   Gravel
   Dirt
   Grass
   Snow
   Moisture Level
   Potholes
Wheel conditions:
   Tire quality
   Tire pressure

Each of the different types of conditions may also have different characteristics or qualities. For example, an asphalt road surface may be new, cracking, or decayed, while potholes may have different depths, and moisture level may describe a dry, wet, or flooded road. As suggested by the “dirt” and “grass” road types, the “road” described by the road conditions may be used to describe any type of surface on which the AV travels, which may not be a previously mapped road (e.g., by other mapping data), and may not require any specific paving or other upkeep for characterizing a road condition in various embodiments. In addition, or as an alternative to determining specific types of road conditions, each road condition may also be associated with a ride quality or smoothness, such that the relative effect of the particular road condition may be scored and evaluated against other road conditions. These quality scores may be used, for example, in evaluating (by the routing or path planning processes) the relative value of traveling a “rough” asphalt road compared to a “smooth” gravel road and may be used to score or rank different types of road conditions. In some embodiments, a road quality score may be determined from the wheel sensor data without expressly determining any particular road condition.

The wheel sensor data captured by the associated sensors may typically be a function of several co-occurring conditions. For example, in addition to the condition of the road itself, the wheel sensor data may also be affected by the particular wear (i.e., tire quality) and tire pressure of each wheel, which may affect the wheel-road interactions as reflected in the wheel sensor data. As such, in one embodiment a combination of conditions may be simultaneously or jointly determined for a portion of wheel sensor data, such as: asphalt (high-quality), moisture level (dry) and wheel condition (normal condition/inflation).

In one embodiment, the wheel sensor data may be processed (e.g., to determine various characteristics such as a road condition) based on various signal processing techniques, such as time-based spectral analysis. In one embodiment, the wheel sensor data from various types of road conditions in conjunction with different types of tire conditions may be captured, labeled, and used as references for signal processing of the received wheel sensor data. The captured data may be from capturing live data from physical vehicles traveling under various conditions or may be generated from simulated environments. In one example, a reference for different types of conditions (and combinations thereof) may be stored and used to pattern-match received signals to the stored reference signals. In this example, the road conditions may be determined based on a numerical optimization of the received wheel sensor data relative to matching one or more of the reference signals.

As another example, a computer model (e.g., via Deep Learning) may be used (and previously trained) to determine a set of conditions in the environment as a function of the received wheel sensor data. The computer model may characterize the wheel sensor data as various magnitudes, frequencies, etc., over time and analyze the wheel sensor data with respect to various road and/or wheel conditions. Training data for the computer model may be generated based on captured and labeled wheel sensor data for different types of conditions, such that the model may learn the associated representation in the wheel sensor data between aspects of the captured wheel sensor data and respective conditions (or a combination thereof) in the environment. In various embodiments, the model may be a multi-class classification, such that various types of conditions (e.g., road conditions, tire conditions, etc.) are considered individual classes that may be predicted by the model. By associating captured wheel sensor data with training data labels, the model is trained to learn parameters that classify incoming wheel sensor data and produce detected conditions from received wheel sensor data. In this embodiment, to predict individual road and/or tire conditions, the received wheel sensor data may be applied to the trained computer model.

In some embodiments, the wheel sensor data may also be processed or pre-processed using additional characteristics (for example, the rate of movement of the vehicle) or normalized to an amount of background sensor data caused by the environment. For example, when the vehicle is stopped, the road effects of travel are generally expected to also stop, such that a background level of sensor information may be determined or filtered. In other examples, the rate of speed may also be used to describe expected frequencies of tire-related conditions for tire conditions that may be a function of the tire rotation. For example, when the tires rotate at two rotations per second, tire-related conditions may be expected to have a frequency of two per-second. These and other techniques may be used to clean or filter the data for processing and may be used as wheel sensor data for the road sensor map or for detection of related road/tire conditions.

As such, the wheel sensor data 330 captured in FIG. 3C from the wheels traveling over the rough area 310B may be processed to detect that the road condition at that portion of the road differs from and is rougher than the surrounding road. In an example in which the wheel sensor data is processed as a road condition, while the rest of the road may be described as smooth asphalt, the rough area 310B may be identified as rough or decaying asphalt.

FIG. 3D shows an example of the road sensor map generated/updated based on travel of the AV 300 through the environment of FIG. 3C. The road sensor map in FIG. 3C is updated to reflect the rough area 310B as a region 315A in the mapped data 320 in the road sensor map. As the AV 300 traveled generally centered in the lane, the rough area 310A in the environment was not encountered by the wheels and thus the general mapped data 320 may remain similar to the prior road sensor map.

FIG. 3E shows an example of modified path planning based on the road sensor map of FIG. 3D. As discussed, the road sensor map may be shared among different AVs and via an external system, such that the road condition information determined by the AV navigating the environment as shown in FIG. 3C and generating a road sensor map (e.g., updating a prior road sensor map) as shown in FIG. 3D may be shared with another vehicle traversing the same road. As such, the AV navigating the environment shown in FIG. 3E may benefit from the road condition information in a prior road sensor map showing the region 315A with a poorer road condition relative to other portions of the road. The path planning module 220 may thus modify the path 325 for the AV 300 in FIG. 3E to avoid the detected region 315A with a reduced road quality. In this example, the modified path is determined as continuing to travel along the right lane, but to drive along the left side of the right lane (e.g., left-justified within the lane). Determining how to modify path planning based on the road sensor map is discussed further in FIG. 4.

In this example, by traveling along the path 325, the AV 300 shown in FIG. 3E does not encounter an additional portion of the road similar to the region 315A; however, the vehicle now encounters the rough area 310A, which may be evaluated as a second road condition with a worse condition than the surrounding road.

FIG. 3F shows the addition of a corresponding region 315B to illustrate the mapped data 320 that now includes the path traversed by the AV 300 in FIG. 3E along with the previously mapped areas, such that the mapped data 320 in FIG. 3F includes a greater portion of the right lane. FIG. 3F also shows an example of a subsequent AV 300 traveling in the environment and benefiting from the mappings of FIGS. 3A-E. The AV 300 of FIG. 3F, as with the AV in FIG. 3E, may modify its path to path 328 to avoid the regions 315A, B in the mapped data 320. In this example, rather than changing position within the lane, the modified path 328 plans a lane change to the left lane of the road. As such, as different AVs (or the same AV at different points in time) travels across different portions of a road, the road conditions may be mapped and shared such that the AVs may modify their control to navigate with respect to learned road conditions based on the wheel sensor data.

FIG. 4 shows an example data processing flow for a road sensor map, according to one embodiment. As discussed above, the AV may receive a prior road sensor map 400 indicating information determined from a previous traversal of the road and subsequent wheel sensor data. The prior road sensor map 400 applicable to the AV may be determined by localizing the AV with respect to other sensor data and objects in the environment. For example, GPS data may be used to determine coordinates of the AV, or camera and/or vision data (e.g., used to generate the local environment model 250) may be compared with mapping data 260 to localize and position the AV within the world and identify the relevant prior road sensor map 400.

The prior road sensor map 400 may be used to navigate 410 the road and for further path planning for the road. The particular ways in which the wheel sensor data and/or road conditions affect motion planning may vary in different embodiments. In general, the AV may prioritize smooth or more comfortable rides and higher-quality roads (e.g., quieter wheel sensor data or conditions such as well-paved asphalt) and deprioritize lower-quality conditions (e.g., louder wheel sensor data or conditions such as gravel or significant potholes). Similarly, the AV may also prioritize obtaining additional mapped areas of the road and traversing different portions of the road to obtain increased regions of mapping data and deprioritize traveling over areas that were recently mapped. In some embodiments, the portions of the road sensor map may also be associated with the time that the respective data was determined. The map data may also associate the data with an information decay, such that the map data may be removed once it is older than a threshold or may be prioritized for vehicles to revisit the region to renew the road condition data. As such, the prior road sensor map 400 may be used in navigating 410 of the road to avoid regions based on the mapped road condition data, to encourage navigation to high-quality regions (based on the mapped road data), or to prioritize exploring to collect additional road condition information.

As the AV navigates the road, the prior road sensor map 400 may be used to update the localization 430 of the AV by comparing the current wheel sensor data (and information derived therefrom) with the information in the prior road sensor map 400. That is, the location of wheel sensor data may be expected to be similar between the prior road sensor map 400 and the wheel sensor data obtained from current navigation by the AV. As such, the currently-received wheel sensor data 420 may be compared with the prior road sensor map 400 to determine an updated localization 430 of the AV, which may include localization of the AV at a higher resolution or with fewer errors than the localization based on other sensor data. The localization may be based on a comparison of the received wheel sensor data 420 and/or a current road sensor map 440 (discussed below) compared with the prior road sensor map 400. The particular location with respect to the prior road sensor map 400 may be determined by pattern matching, machine learning, e.g., Deep Learning, and/or solving an inverse problem with respect to the prior road sensor map 400. This localization may enable the AV to more accurately determine the location of the AV and in some embodiments may be used to localize individual wheels (e.g., position and rotation).

In addition, as the road is navigated, the received wheel sensor data 420 may be used to generate a current road sensor map 440 reflecting the wheel sensor data experienced as the road is traversed. As shown in the examples of FIGS. 3A-3F, the wheel sensor data (and information from processing the wheel sensor data, such as road conditions) determined from traversing the road may be different or new from the information present in the prior road sensor map 400. As such, the received wheel sensor data 420 may be used to update the stored road sensor map, for example by sending road condition data to an external system or to other AVs. The road sensor map 440 may be generated by associating wheel sensor data (and/or further processing thereof) with the locations of the AV at which the wheel sensor data was received. In some embodiments, the road sensor map 440 may store raw received wheel sensor data 420 in association with locations in the road sensor map 440. In further examples, the wheel sensor data may be processed, for example, with time or frequency-based algorithms, to further describe the wheel sensor data.

The AV may also determine 450 one or more conditions based on the wheel sensor data and/or the road sensor map 440 to characterize portions of the environment as having various types of road conditions 460 with respect to various road conditions 460. Example road conditions are discussed above, and may include, for example, different types of roads (e.g., gravel, asphalt, and conditions of those roads, such as newly-paved, cracked, potholes, etc.).

Additional types of conditions determined from the wheel sensor data may also be used to affect control of the AV. For example, the detected conditions may include information about the tire wear or tire pressure, and may be used to indicate, for example, the expected length of continued operation before service is recommended, or to indicate that service is recommended now, and prioritize navigation towards a location to service the AV.

To determine 450 the road conditions 460, the wheel sensor data may be processed with various techniques, such as pattern matching, time- or frequency analysis, computer modeling, or any other suitable approach as discussed above. The conditions may then be added to the road sensor map 440 and may be used for further localization of the AV, to modify the prior road sensor map, or to affect operation of the AV as discussed above.

### Example Embodiments

Various embodiments of claimable subject matter includes the following examples.

Example 1 provides a method including: receiving wheel sensor data captured by one or more sensors proximate to one or more wheels of an autonomous vehicle and describing wheel-road interactions; determining a position of the autonomous vehicle; and generating a road sensor map for the position based on the wheel sensor data.

Example 2 provides for the method of example 1, wherein the one or more sensors include an audio sensor, a vibration sensor, or a pressure sensor.

Example 3 provides for the method of any of examples 1-2, The method of claim 1, further comprising updating the position based on a comparison of the road sensor map with a prior road sensor map associated with the position.

Example 4 provides for the method of any of examples 1-3, further comprising navigating the autonomous vehicle based on a prior road sensor map.

Example 5 provides for the method of example 4, further comprising identifying a region of interest in the previous road sensor map; and the navigating comprises navigating to the region of interest to capture sensor data of the region of interest.

Example 6 provides for the method of example 4, wherein the navigating includes avoiding a region based on the previous road sensor map.

Example 7 provides for the method of example 4, wherein the previous road sensor map includes an information decay of characteristics in the previous road sensor map; and the navigating includes navigating based on the information decay.

Example 8 provides for the method of any of examples 1-7, wherein the road characteristics include a road type and/or quality of a portion of the road.

Example 9 provides for the method of any of examples 1-8, wherein one or more tire conditions are determined based on the wheel sensor data.

Example 10 provides a system including: receiving wheel sensor data captured by one or more sensors proximate to one or more wheels of an autonomous vehicle and describing wheel-road interactions; determining a position of the autonomous vehicle; and generating a road sensor map for the position based on the wheel sensor data.

Example 11 provides for the system of example 10, wherein the one or more sensors include an audio sensor, a vibration sensor, or a pressure sensor.

Example 12 provides for the system of any of examples 10-11, wherein the instructions are further executable for updating the position based on a comparison of the road sensor map with a prior road sensor map associated with the position.

Example 13 provides for the system of any of examples 10-12, wherein the instructions are further executable for navigating the autonomous vehicle based on a prior road sensor map.

Example 14 provides for the system of example 13, wherein the instructions are further executable for identifying a region of interest in the previous road sensor map; and the navigating comprises navigating to the region of interest to capture sensor data of the region of interest.

Example 15 provides for the system of example 13, wherein the navigating includes avoiding a region based on the previous road sensor map.

Example 16 provides for the system of example 13, wherein the previous road sensor map includes an information decay of characteristics in the previous road sensor map; and the navigating includes navigating based on the information decay.

Example 17 provides for the system of any of examples 10-16, wherein the road characteristics include a road type and/or quality of a portion of the road.

Example 18 provides for the system of any of examples 10-17, wherein one or more tire conditions are determined based on the wheel sensor data.

Example 19 provides a non-transitory computer-readable medium containing instructions executable by one or more processors, including: receiving wheel sensor data captured by one or more sensors proximate to one or more wheels of an autonomous vehicle and describing wheel-road interactions; determining a position of the autonomous vehicle; and generating a road sensor map for the position based on the wheel sensor data.

Example 20 provides for the computer-readable medium of example 19, wherein the one or more sensors include an audio sensor, a vibration sensor, or a pressure sensor.

### Other Implementation Notes, Variations, and Applications

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

Specifications, dimensions, and relationships outlined herein (e.g., the number of processors, logic operations, etc.) have been offered for purposes of example and teaching only. Such information may be varied considerably without departing from the spirit of the present disclosure or the scope of the appended claims. In the foregoing description, various non-limiting example embodiments have been described with reference to particular arrangements of components. Various modifications and changes may be made to such embodiments without departing from the scope of the appended claims. This description and drawings are, accordingly, to be regarded in an illustrative rather than in a restrictive sense.

Note that with the numerous examples provided herein, interaction may be described in terms of two, three, four, or more components. However, this has been done for purposes of clarity and example only. It should be appreciated that the system can be consolidated in any suitable manner. Along similar design alternatives, any of the illustrated components, modules, and elements of the figures may be combined in various possible configurations, all of which are clearly within the broad scope of this disclosure.

Note that in this specification, references to various features (e.g., elements, structures, modules, components, steps, operations, characteristics, etc.) included in “one embodiment,” “example embodiment,” “an embodiment,” “another embodiment,” “some embodiments,” “various embodiments,” “other embodiments,” “alternative embodiment,” and the like, are intended to mean that any such features are included in one or more embodiments of the present disclosure, but may or may not necessarily be combined in the same embodiments.

Numerous other changes, substitutions, variations, alterations, and modifications may be ascertained to one skilled in the art and it is intended that the present disclosure encompass all such changes, substitutions, variations, alterations, and modifications as falling within the scope of the appended claims. Note that all optional features of the systems and methods described above may also be implemented with respect to the methods or systems described herein and specifics in the examples may be used anywhere in one or more embodiments.

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
receiving wheel sensor data captured by one or more sensors proximate to one or more wheels of a vehicle and describing wheel-road interactions;
determining a position of the vehicle; and
generating a road sensor map for the position based on the wheel sensor data.

2. The method of claim 1, wherein the one or more sensors include an audio sensor, a vibration sensor, or a pressure sensor.

3. The method of claim 1, further comprising updating the position based on a comparison of the road sensor map with a prior road sensor map associated with the position.

4. The method of claim 1, further comprising navigating the vehicle based on a prior road sensor map.

5. The method of claim 4, further comprising identifying a region of interest in the previous road sensor map; and the navigating comprises navigating to the region of interest to capture sensor data of the region of interest.

6. The method of claim 4, wherein the navigating includes avoiding a region based on the previous road sensor map.

7. The method of claim 4, wherein the previous road sensor map includes an information decay of characteristics in the previous road sensor map; and the navigating includes navigating based on the information decay.

8. The method of claim 1, wherein the road characteristics include a road type and/or quality of a portion of the road.

9. The method of claim 1, wherein one or more tire conditions are determined based on the wheel sensor data.

10. A system, comprising:
a processor; and
a non-transitory computer-readable storage medium containing instructions for execution by the processor for:
receiving wheel sensor data captured by one or more sensors proximate to one or more wheels of a vehicle and describing wheel-road interactions;
determining a position of the vehicle; and
generating a road sensor map for the position based on the wheel sensor data.

11. The system of claim 10, wherein the one or more sensors include an audio sensor, a vibration sensor, or a pressure sensor.

12. The system of claim 10, wherein the instructions are further executable for updating the position based on a comparison of the road sensor map with a prior road sensor map associated with the position.

13. The system of claim 10, wherein the instructions are further executable for navigating the vehicle based on a prior road sensor map.

14. The system of claim 13, wherein the instructions are further executable for identifying a region of interest in the previous road sensor map; and the navigating comprises navigating to the region of interest to capture sensor data of the region of interest.

15. The system of claim 13, wherein the navigating includes avoiding a region based on the previous road sensor map.

16. The system of claim 13, wherein the previous road sensor map includes an information decay of characteristics in the previous road sensor map; and the navigating includes navigating based on the information decay.

17. The system of claim 10, wherein the road characteristics include a road type and/or quality of a portion of the road.

18. The system of claim 10, wherein one or more tire conditions are determined based on the wheel sensor data.

19. A non-transitory computer-readable medium containing instructions executable by one or more processors for:
receiving wheel sensor data captured by one or more sensors proximate to one or more wheels of a vehicle and describing wheel-road interactions;
determining a position of the vehicle; and
generating a road sensor map for the position based on the wheel sensor data

20. The computer-readable medium of claim 19, wherein the one or more sensors include an audio sensor, a vibration sensor, or a pressure sensor.
